(19) United States
(12) Patent Application Publication
(10) Pub. No.: US 2019/0249861 A1
(43) Pub. Date: Aug. 15, 2019

(54) PULSED SHOCK LIGHT DEVICE

(71) Applicant: LI-YEN CHEN, TAIPEI (TW)

(72) Inventor: LI-YEN CHEN, TAIPEI (TW)

(21) Appl. No.: 15/895,291

(22) Filed: Feb. 13, 2018

(51) Int. Cl. F21V 33/00; F21V 7/00; F21V 21/08; F41H 13/00

(52) U.S. Cl. CPC F21V 33/0064; F21V 7/0091; F21Y 2113/13; F41H 13/0087; F21V 21/0816

(57) ABSTRACT

A pulsed shock light device includes an assembly of a body and a pulsed light module. The body is formed with a flat area and a curved area opposite to the flat area to facilitate gripping thereof by a user. The body includes an energy storage unit and an actuating module electrically connected with the pulsed light module. The pulsed light module includes a light emitting chipset for emitting light with different colors and dual-carrier frequencies and an optical lens assembled with the light emitting chipset. The optical lens allows light to be outputted to form a diameter of an illumination range of about 21 cm˜30 cm at a distance between about 200 cm˜300 cm, which may cover 150%˜200% of the area of a human head, thereby achieving more effective disorienting effects than the prior art.

### BACKGROUND OF THE INVENTION

The present invention relates to a pulsed shock light device, and more specifically, to an assembly of a body and a pulsed light module with an optical lens and LED chips for outputting shock light with different colors and dual-carrier frequencies.

Electrical equipment incorporating a flashlight or the like and a plurality of LEDs has been known to stimulate visual senses and cause disorientation in attackers by outputting pulsed or shock light with different colors and dual-carrier frequencies. For example, U.S. Pat. No. 8,984,234 entitled “MULTI-COLOR FLASHLIGHT HAVING GUARDING STICK” provides a typical example of such.

Said patent discloses a cylindrical receptacle coupled with a light mount and groups of red and blue LED chips alternatingly arranged therein. When the flashlight is activated via an actuating module, the red and blue LED chips controlled by a flashing device emit a pulse of alternating red and blue light in order to shock and disorient adversaries by causing them to have vertigo. This is particularly useful for law enforcement officers, security guards, or the like.

A drawback of this type of flashlight or pulsed shock light device in terms of its structure and application is that the plurality groups of red and blue LED chips need to be arranged in an alternating fashion, which inevitably demands a larger light mount in order to accommodate them. Not only does this increase the weight and the manufacturing cost of the device, the form in which the pulsed light are emitted by the LED chips is not conducive for targeting smaller areas of the head, such as the area of the eyes, thereby reducing the effectiveness of such a device.

As known by those of ordinary skill in the art, the lengths and sizes of conventional flashlights or pulsed shock light devices tend to be quite large, which makes them inconvenient for women or children to use or carry around, and cannot be easily drawn under emergency situations. These are not desirable characteristics.

Representatively speaking, those prior-art documents disclose the structure and application of conventional flashlights or pulsed shock light devices. They also reflect some of the shortcomings when the devices are being used in practice. A re-design of the structure different from that of the conventional is called for and will allow for a change in the way it is used. A more effective pulsed shock light transmission and mechanism should also be achieved to overcome the drawbacks of the prior art.

A solution to these drawbacks has not been disclosed or taught by the aforementioned prior-art.

### SUMMARY OF THE INVENTION

In view of the above, the present invention provides a pulsed shock light device includes an assembly of a body and a pulsed light module. The body is formed with a flat area and a curved area opposite to the flat area to facilitate gripping thereof by a user. The body includes an energy storage unit and an actuating module electrically connected with the pulsed light module. The pulsed light module includes a light emitting chipset for emitting light of different colors and dual-carrier frequencies and an optical lens assembled with the light emitting chipset. The optical lens allows light to be outputted to form a diameter of an illumination range of about 21 cm˜30 cm at a distance between about 200 cm˜300 cm, which covers 150% 200% of the area of a human head, thereby achieving more effective disorienting effects than the prior art.

According to the pulsed shock light device of the present invention, a groove is formed on the flat area of the body to accommodate an affixed member that is a strip-shaped structure made of rubber or similar material to increase friction or resistance between a user's hand and the device. Additionally, the affixed member is allowed to be pulled away from the device to elastically fasten the fingers of the users to prevent the device from slipping or falling.

According to the pulsed shock light device of the present invention, the optical lens forms a light guide of a solid bowl structure, and is defined with a center reference axis. A concave portion is provided at the bottom of the optical lens to receive the light emitting chipset. A (columnar) chamber is provided at the center of the optical lens extending along the center reference axis for guiding light towards the center to thus increase the intensity of light at the center of the illumination range (or illumination profile), allowing the pulsed shock light to be focused more around the areas of the eyes of an attacker.

### BRIEF DESCRIPTION OF THE DRAWINGS

FIG. 1 is a schematic diagram depicting the structures of a body, a pulsed light module, an actuating module, and a circuit module of a pulsed shock light device in accordance with an embodiment of the present invention.

FIG. 2 is a schematic diagram depicting the structures of a body, a pulsed light module, and a buzzer of a pulsed shock light device in accordance with another embodiment of the present invention.

FIG. 3 is a cross-sectional view illustrating light guided by an optical lens of the pulsed shock light device in accordance with an embodiment of the present invention.

FIG. 4 is a schematic diagram depicting illumination of FIG. 3 in which the center of the illumination profile or illumination range focuses on the area of the eyes of a head.

FIG. 5 is a cross-sectional view depicting a control key being operated by a user in accordance with an embodiment of the present invention.

FIG. 6 is a cross-sectional view depicting a control key being operated by a user in accordance with another embodiment of the present invention.

FIG. 7 is a schematic diagram depicting an affixed member elastically fastened on the fingers of the user in accordance with an embodiment of the present invention.

FIG. 8 is a schematic diagram depicting a ring structure provided on the body of the pulsed shock light device in accordance with another embodiment of the present invention.

### DETAILED DESCRIPTION

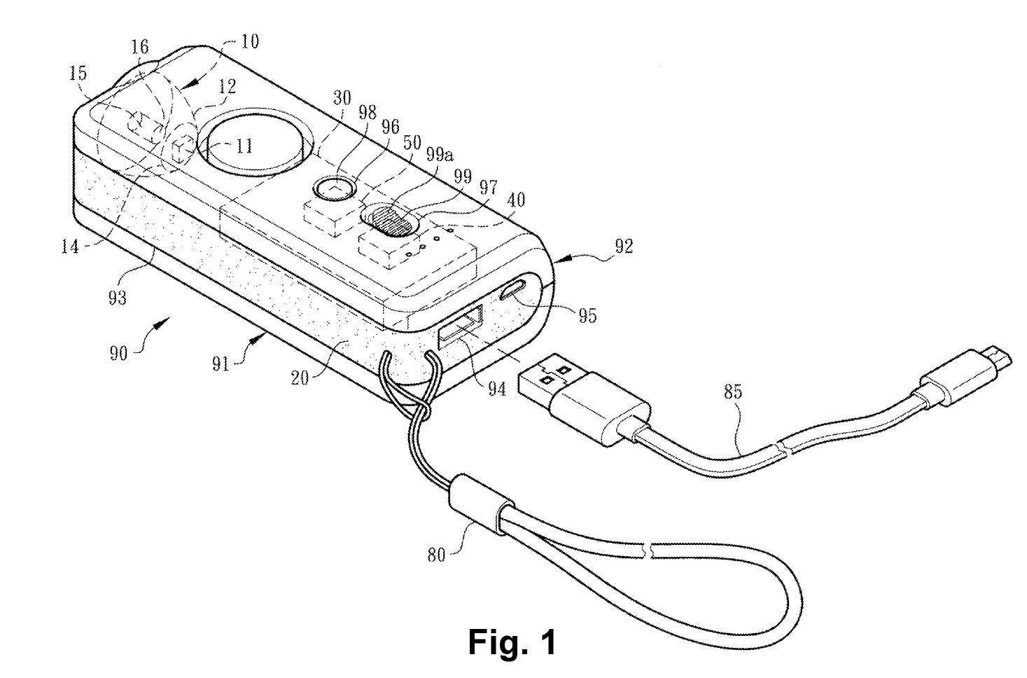

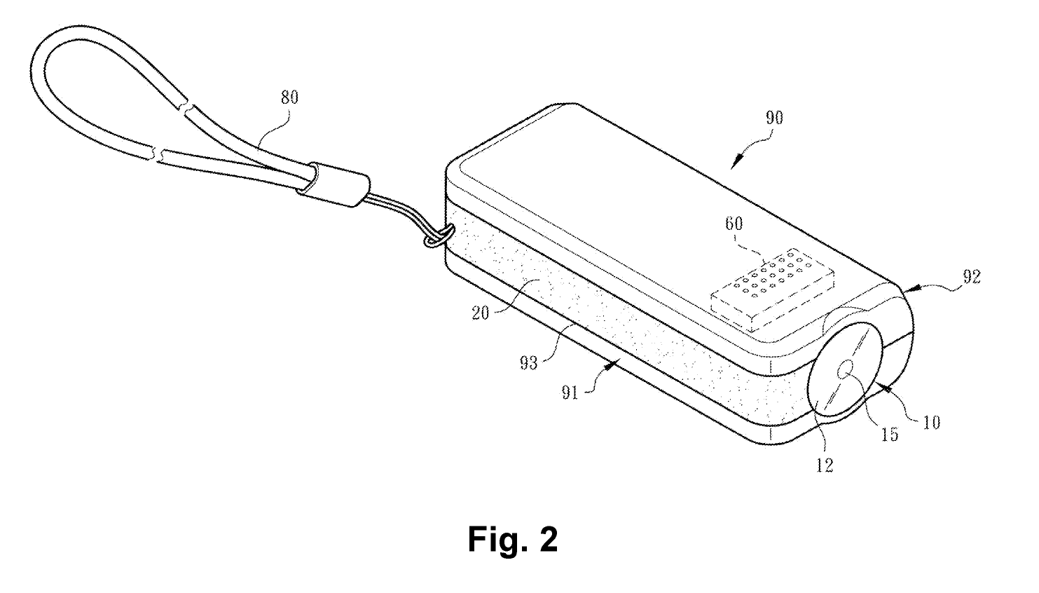

Referring to FIGS. 1 and 2, a pulsed shock light device in accordance with the present invention is shown, which includes a body and a pulsed light module that are generally represented by reference numerals 90 and 10, respectively. The body 90 is a rectangular structure formed with a flat area 91 and a curved area 92 opposite to the flat area 91. The shape or profile of the curved area 92 is suited to the ergonomics of a human hand (or the part of a hand between the index finger and the thumb) to facilitate holding the device.

In the following descriptions, terms such as “front”, “front end”, “bottom”, “rear end”, “outside”, and “inside” are referenced with respect to the directions shown in the diagrams.

In the diagrams, the pulsed light module 10 is assembled at the front of the body 90. A groove 93 is provided on the flat area 91 to accommodate or receive an affixed member 20. The affixed member 20 is a strip-shaped structure made of rubber or similar materials to increase the coefficient of friction or resistance between the body 90 and the hand holding it.

In this embodiment, an energy storage unit 30, an actuating module 40 electrically connected with the pulsed light module 10, and a circuit module 50 are provided inside the body 90. The circuit module 50 is well-known in the art and will not be described in details. A buzzer 60 is also provided in the body 90 as shown in FIG. 2, for example.

In FIG. 1, a strap 80 is also shown to be attached to the body 90 for slipping or hooking onto a user's hand to help the user get hold of the body 90. A primary port 94 and a secondary port 95 are provided on the body 90 (or the bottom of the body 90) and can be selectively connected with a transmission cable 85, whereby the pulsed shock light device may be used as a mobile energy storage power bank for charging various electronic devices and/or can be charged with a power supply.

In this embodiment, the body 90 is provided with a first hole 96 and a second hole 97 for receiving a first control key 98 and a second control key 99, respectively. The first and second control keys 98 and 99 control the “on/off” of the pulsed light module 10.

Additionally, the height (or position) of the first control key 98 is slightly lower than the surface of the body 90 or the height (or position) of the first hole 96 to reduce actuating the first control key 98 by accident. The second hole 97 is a long-oval shaped structure, and the second control key 99 has a raised portion 99a to be operated by the user, such that the second control key 99 can be freely moved within the second hole 97.

In an embodiment, the pulsed light module 10 includes a light emitting chipset 11 capable of emitting light of different colors and dual-carrier frequencies, and an optical lens 12 assembled with the light emitting chipset 11. The light emitting chipset 11 are composed of a LED chip that emit white, red and blue light, or a configuration of two red LED chips, one white LED chip, and two blue LED chips arranged in an array or at intervals and enclosed together in the same package to reduce the size and weight of the light emitting chipset 11.

When the user operates or presses the first control key 98, the pulsed light module 10 can be turned on/off to output white light, so it can be used for illumination or as a flashlight. When the user operates the second control key 99, the pulsed light module 10 can be turned on/off to output alternating red and blue flashing light, which may occur with the selective triggering or actuating of the buzzer 60 to sound an alarm.

It should be noted that the frequencies of red and blue LED chips are both modulated at about 50-60 Hz in addition to being modulated with a frequency of about 12-15 Hz. Therefore, each of the red and blue LED chips can emit dual-carrier pulsed light with dual frequencies of 50-60 Hz and 12-15 Hz. The luminous intensity outputted by the flashing light emitting chipset 11 (or both the red LED chips and blue LED chips) is at least 7,000 cd (candela). The alternating flashing of the red and blue light with said flashing frequencies results in an increased dazzling effect on the eyes.

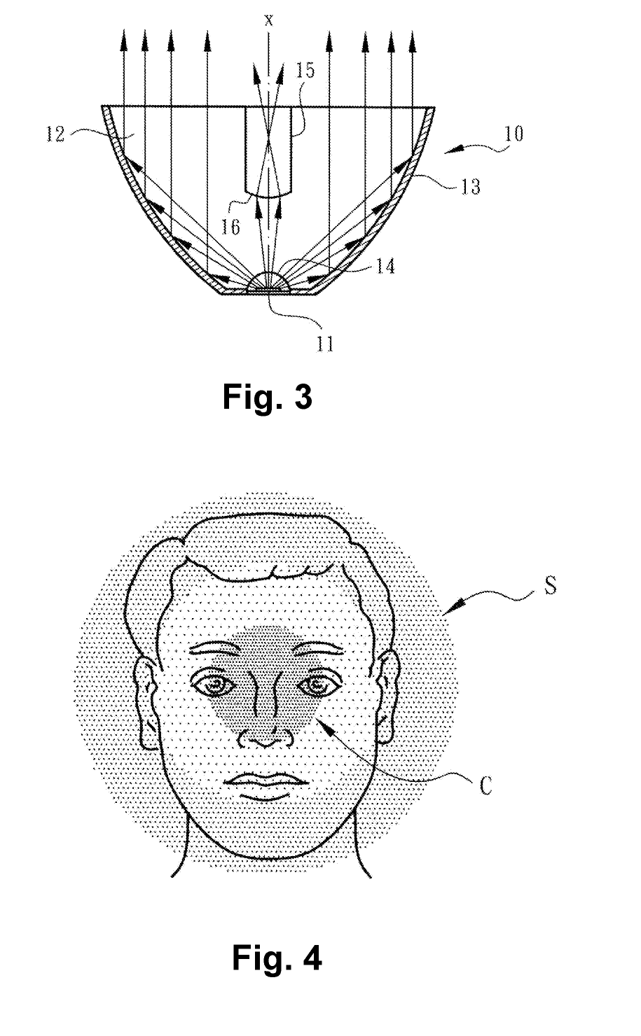

With reference to FIGS. 3 and 4, a Total Internal Reflection (TIR) lens or a similar optical element can be selected as the optical lens 12. The optical lens 12 forms a light guide in the shape of a solid bowl and is defined with a center reference axis X. A light guiding layer 13 is provided on the periphery of the optical lens 12 to guide the traveling path of a light.

In this embodiment, a concave portion 14 is provided at the bottom of the optical lens 12 for receiving the light emitting chipset 11. A (column-shaped) chamber 15 with a curved face 16 at the bottom thereof is provided at the center of the optical lens 12 extending along the center reference axis X for guiding light rays towards the center before outputting them.

As shown in the diagrams, light rays from the light emitting chipset 11 pass through the concave portion 14, some of them are emitted on the light guiding layer 13 before being outputted, while some other light rays from the light emitting chipset 11 are refracted and focused in the chamber 15 via the curved face 16 before being outputted. As such, as shown in FIG. 4, the intensity of light at the center area C of the illumination range S (or illumination profile) can be increased, in other words, the pulsed shock light is more focused on the areas of the head and eyes, thereby increasing the effect of dizziness.

In one embodiment, while an angle between the periphery of the optical lens 12 and the center reference axis X (or a “spreading angle” between the periphery of the optical lens 12 relative to the center reference axis X) is about three degrees (3°), i.e., the spreading angle of the periphery of the optical lens is about 6° in total, (i.e. the angular spreading of the optical lens 12 shown in FIG. 3 is 3° on both sides of the center reference axis X), the light can be outputted to form a diameter of the illumination range S of about 21 cm˜30 cm at a distance between about 200 cm˜300 cm, which covers about 150%˜200% of the area or range of a human head, resulting in disorienting and dizziness effects more ideal than the prior art.

It should be noted that the above diameter of about 21 cm˜30 cm of the illumination range S is derived from formula: 2*200 cm*Tan 3°≈21 cm 2*300 cm*Tan 3°≈31 cm.

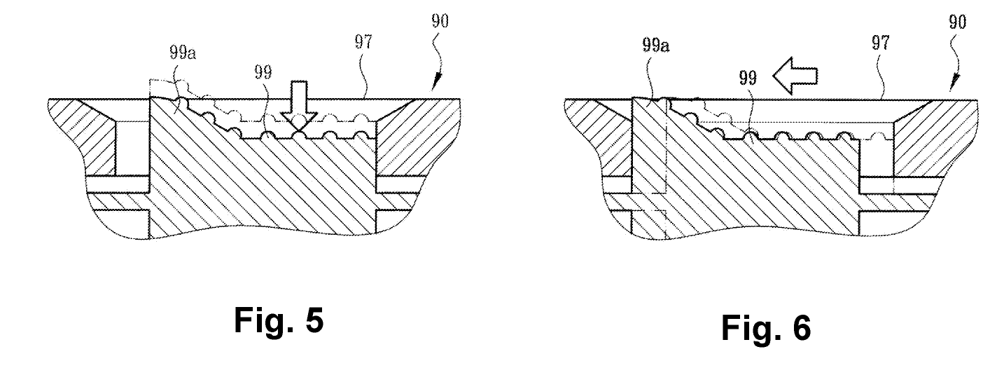

Referring to FIGS. 5 and 6, an implementation for reducing accidental touch of the second control key 99 is illustrated. In FIG. 5, it is shown that the user needs to press on the second control key 99 in a downward direction as indicated in the diagram, and the user is then allowed to move the second control key 99 within the second hole 97 to turn on/off the pulsed light module 10 for outputting light.

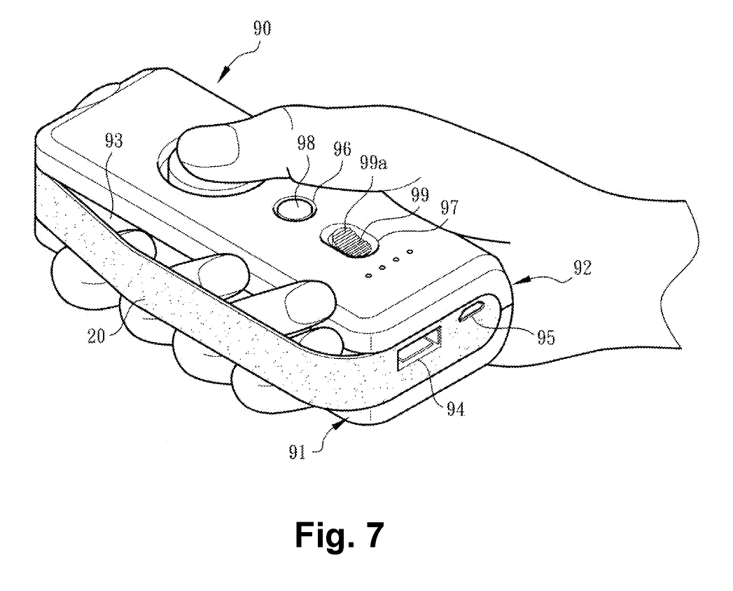

FIG. 7 depicts an implementation in which the affixed member 20 is allowed to be elastically pulled away from the device, such that it can elastically fasten the user's fingers to prevent the body 90 from slipping or falling.

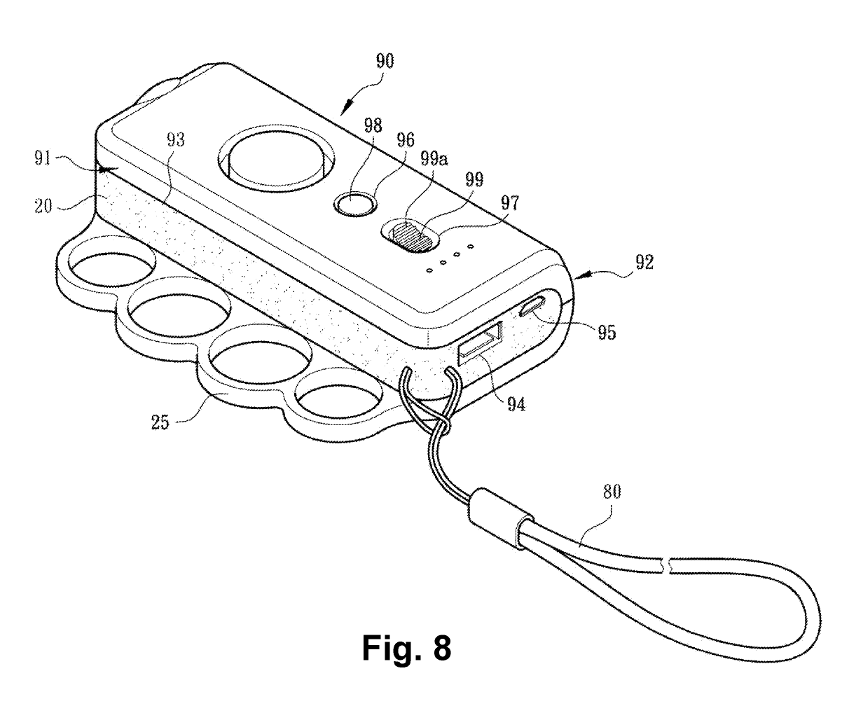

FIG. 8 depicts another implementation in which protruding ring structure 25 is provided on the body 90 (or the flat area 91) to allow the user's fingers to slip into them to increase the stability of the hand in holding the body 90.

Representatively speaking, the pulsed shock light device is light and easy to carry, and includes the following advantages and features compared to the prior art:

1. The assembled structure of the body 90 and the pulsed light module 10 has been redesigned. For example, the body 90 includes the flat area 91, the curved area 92, and the affixed member 20 for increasing friction or securing, and the body 90 is provided with the actuating module 40 and the buzzer 60. The turning on/off of the affixed member 20 is controlled by the first control key 98 and the second control key 99. The pulsed light module 10 is provided with the light emitting chipset 11 for emitting white, red and blue light and the optical lens 12. The optical lens 12 includes the concave portion 14 for receiving the light emitting chipset 11, the columnar chamber 15 and the curved face 16 to increase the intensity of the light at the center area C of the illumination range S. These are in contrast with the traditional structure.

2. More particularly, the light emitting chipset 11 includes red and blue LED chips, which are both modulated at a frequency of about 50-60 Hz in addition to being modulated with a frequency of about 12-15 Hz. Therefore, each of the red and blue LED chips can emit dual-carrier pulsed light with dual frequencies of 50-60 Hz and 12-15 Hz. Additionally, the angular spreading of the periphery of the optical lens 12 is about 3 degrees, so that while at a distance of about 200 cm˜300 cm, the illumination range S will be capable of covering 150%˜200% of the area of a human head, thereby creating more disorienting and dizziness effects than the prior art.

Therefore, the present invention provides an effective pulsed shock light device that is structurally different from the prior art and has advantages over the prior art.

The above descriptions are merely provided to impart examples of the present invention, rather than limitations of the scope of the present invention, and various alterations and changes can be made thereto without departing from the spirit and broader aspects of the invention as defined in the appended claims, which are to be interpreted in accordance with the principles of patent law including the doctrine of equivalents.

What is claimed is:

1. A pulsed shock light device comprising an assembly of a body and a pulsed light module; the body including an energy storage unit, an actuating module electrically connected with the pulsed light module, and a circuit module;
the pulsed light module including a light emitting chipset for emitting light with different colors and dual-carrier frequencies and an optical lens assembled with the light emitting chipset, the light emitting chipset including at least one white, one red and one blue light emitting diode (LED) chips for respectively emitting at least white, red and blue light;
the optical lens being a solid-bowl structure and defined with a center reference axis, the optical lens being provided with a light guiding layer and a concave portion for receiving the light emitting chipset, wherein the optical lens allows the light emitting chipset to output light to form a diameter of an illumination range of about 21 cm˜30 cm, which covers 150%˜200% of the area of a human head.

2. The pulsed shock light device of claim 1, wherein the pulsed light module is assembled at the front of the body, a buzzer is provided inside the body, and a primary port and a secondary port are provided on the body for connecting with a transmission cable.

3. The pulsed shock light device of claim 1, wherein the body forming a flat area and a curved area opposite to the flat area, and a groove is provided on the flat area of the body for accommodating an strip-shaped affixed member.

4. The pulsed shock light device of claim 2, wherein the body forming a flat area and a curved area opposite to the flat area, and a groove is provided on the flat area of the body for accommodating an strip-shaped affixed member.

5. The pulsed shock light device of claim 1, wherein a protruding ring structure is provided on the body.

6. The pulsed shock light device of claim 2, wherein a protruding ring structure is provided on the body.

7. The pulsed shock light device of claim 1, wherein a first hole and a second hole are provided on the body for receiving a first control key and a second control key, respectively, the first and second control keys control the on and off of the pulsed light module, and
the height of the first control key is lower than the height of the surface of the body, the second hole is a long-oval shaped structure, the second control key includes a raised portion to allow a user to operate, such that the second control key is movable within the second hole.

8. The pulsed shock light device of claim 2, wherein a first hole and a second hole are provided on the body for receiving a first control key and a second control key, respectively, the first and second control keys control the on and off of the pulsed light module, and
the height of the first control key is lower than the height of the surface of the body, the second hole is a long-oval shaped structure, the second control key includes a raised portion to allow a user to operate, such that the second control key is movable within the second hole.

9. The pulsed shock light device of claim 1, wherein the light emitting chipset of the pulsed light module includes two red LED chips, one white LED chip, and two blue LED chips arranged in an array or at intervals and enclosed in the same package, the red and blue LED chips in the light emitting chipset can emit dual-carrier pulsed light with dual frequencies of 50-60 Hz and 12-15 Hz, and the luminous intensity outputted by the light emitting chipset is at least 7,000 candela (cd).

10. The pulsed shock light device of claim 2, wherein the light emitting chipset of the pulsed light module includes two red LED chips, one white LED chip, and two blue LED chips arranged in an array or at intervals and enclosed in the same package, the red and blue LED chips in the light emitting chipset can emit dual-carrier pulsed light with dual frequencies of 50-60 Hz and 12-15 Hz, and the luminous intensity outputted by the light emitting chipset is at least 7,000 candela (cd).

11. The pulsed shock light device of claim 7, wherein the light emitting chipset of the pulsed light module includes two red LED chips, one white LED chip, and two blue LED chips arranged in an array or at intervals and enclosed in the same package, the red and blue LED chips in the light emitting chipset can emit dual-carrier pulsed light with dual frequencies of 50-60 Hz and 12-15 Hz, and the luminous intensity outputted by the light emitting chipset is at least 7,000 candela (cd).

12. The pulsed shock light device of claim 8, wherein the light emitting chipset of the pulsed light module includes two red LED chips, one white LED chip, and two blue LED chips arranged in an array or at intervals and enclosed in the same package, the red and blue LED chips in the light emitting chipset can emit dual-carrier pulsed light with dual frequencies of 50-60 Hz and 12-15 Hz, and the luminous intensity outputted by the light emitting chipset is at least 7,000 candela (cd).

13. The pulsed shock light device of claim 1, wherein a Total Internal Reflection lens is selected as the optical lens, a columnar chamber with a curved face at the bottom of the chamber is provided at the center of the optical lens along the center reference axis, and an angular spreading of the periphery of the optical lens is expanded by three degrees (3°) in a direction away from the center reference axis.

14. The pulsed shock light device of claim 2, wherein a Total Internal Reflection lens is selected as the optical lens, a columnar chamber with a curved face at the bottom of the chamber is provided at the center of the optical lens along the center reference axis, and an angular spreading of the periphery of the optical lens is expanded by three degrees (3°) in a direction away from the center reference axis.

15. The pulsed shock light device of claim 7, wherein a Total Internal Reflection lens is selected as the optical lens, a columnar chamber with a curved face at the bottom of the chamber is provided at the center of the optical lens along the center reference axis, and an angular spreading of the periphery of the optical lens is expanded by 3° in a direction away from the center reference axis.

16. The pulsed shock light device of claim 8, wherein a Total Internal Reflection lens is selected as the optical lens, a columnar chamber with a curved face at the bottom of the chamber is provided at the center of the optical lens along the center reference axis, and an angular spreading of the periphery of the optical lens is expanded by 3° in a direction away from the center reference axis.

17. The pulsed shock light device of claim 1, wherein a strap is attached to the body for slipping or hooking onto a user's hand to help the user get hold of the body.

18. The pulsed shock light device of claim 2, wherein a strap is attached to the body for slipping or hooking onto a user's hand to help the user get hold of the body.
